(19) United States
(12) Patent Application Publication
(10) Pub. No.: US 2013/0271508 A1
(43) Pub. Date: Oct. 17, 2013

(54) DISPLAY DEVICE, DISPLAY CONTROL METHOD, AND RECORDING MEDIUM

(71) Applicant: CASIO COMPUTER CO., LTD., Tokyo (JP)

(72) Inventors: Keiichi KANEKO, Kawasaki-shi (JP); Nobuo IIZUKA, Tokyo (JP); Masaaki KIKUCHI, Tokyo (JP); Takeshi IMAI, Tokyo (JP)

(73) Assignee: CASIO COMPUTER CO., LTD., Tokyo (JP)

(21) Appl. No.: 13/860,490

(22) Filed: Apr. 10, 2013

(30) Foreign Application Priority Data
Apr. 13, 2012 (JP) 2012-092284
Mar. 6, 2013 (JP) 2013-044116

(51) Int. Cl. G09G 5/10

(52) U.S. Cl. CPC G09G 5/10
USPC 345/690

(57) ABSTRACT

In a portable terminal, a controller converts a tag ID as information to be transmitted to a marker used for visible light communication. The controller and a driver display the converted marker in a display. The controller and the driver adjust a display mode of the marker displayed on the display.

### CROSS-REFERENCE TO RELATED APPLICATION

This application claims the benefit of Japanese Patent Application No. 2012-092284, filed on Apr. 13, 2012, and Japanese Patent Application No. 2013-044116, filed on Mar. 6, 2013, and the entire disclosure of which is incorporated by reference herein.

### FIELD

This application relates to a display device, a display control method, and a recording medium.

### BACKGROUND

There is a conventionally known technique of transmitting information by making an image capturing device capture information visualized in a predetermined pattern or the like and converting the visualized information to digital information on the image capture side.

In such a technical field, there is a technique known as Unexamined Japanese Patent Application Kokai Publication No. 2008-035154. The literature introduces a technique of transmitting information by visible light communication between cellular phones. Specifically, a cellular phone on the transmission side converts information to be transmitted to modulation of brightness and controls light generation by a light generator. A cellular phone on the reception side successively captures images of the cellular phone on the transmission side including the light generator so as to be included in the angle of view and decodes information from a brightness modulation region included in the captured image.

In the conventional technique, changes in ambient environment are not considered. It is assumed that information transmission by visible light communication is excellently performed in environment in which a cellular phone is usable normally.

In reality, however, in the case of using such a portable terminal, the ambient environment in which visible light communication is performed is not often constant. There is consequently a problem that the user has to find a place where the visible light communication is performable.

### SUMMARY

The present invention has been achieved in consideration of such a problem, and an object of the invention is to enable information transmission with visible light to be excellently performed.

To achieve the object, a display device according to a first aspect of the present invention includes: a display; a converter for converting information to be transmitted to a marker used for visible light communication; a display controller for displaying the marker converted by the converter on the display; and

an adjuster for adjusting a display mode of the marker displayed on the display.

To achieve the object, a display control method according to a second aspect of the present invention includes:

a converting step of converting information to be transmitted to a marker used for visible light communication;

a display control step of displaying the marker converted in the converting step; and

an adjusting step of adjusting a display mode of the marker displayed on the display control step.

To achieve the object, a recording medium according to a third aspect of the invention stores a program which makes a computer having a display device function as:

a converter for converting information to be transmitted to a marker used for visible light communication;

a display controller for displaying the marker converted by the converter in a display; and

an adjuster for adjusting a display mode of the marker displayed on the display.

### BRIEF DESCRIPTION OF THE DRAWINGS

A more complete understanding of this application can be obtained when the following detailed description is considered in conjunction with the following drawings, in which:

FIG. 1 is a diagram illustrating an example of layout of portable terminals and a server constructing an information providing system according to a first embodiment of the present invention;

FIG. 2 is a diagram illustrating an example of the configuration of the portable terminal in the embodiment;

FIG. 3 is a first flowchart illustrating an example of operations performed by the portable terminal in the embodiment;

FIG. 4 is a second flowchart illustrating an example of operations performed by the portable terminal in the embodiment;

FIG. 5A is a diagram illustrating a first example of an inclination of the portable terminal in the embodiment;

FIG. 5B is a diagram illustrating a second example of an inclination of the portable terminal in the embodiment;

FIG. 6A is a diagram illustrating a first example of a change of the display mode of the marker in the embodiment;

FIG. 6B is a diagram illustrating a second example of a change of the display mode of the marker in the embodiment;

FIG. 6C is a diagram illustrating a third example of a change of the display mode of the marker in the embodiment;

FIG. 7A is a diagram illustrating a fourth example of a change of the display mode of the marker in the embodiment;

FIG. 7B is a diagram illustrating a fifth example of a change of the display mode of the marker in the embodiment;

FIG. 7C is a diagram illustrating a sixth example of a change of the display mode of the marker in the embodiment;

FIG. 8 is a diagram illustrating an example of the configuration of a program ROM in a portable terminal according to a second embodiment of the present invention;

FIG. 9 is a flowchart illustrating an example of operations performed by the portable terminal of the embodiment and another portable terminal;

FIG. 10A is a first flowchart illustrating an example of operations performed by a portable terminal according to a third embodiment of the present invention; and

FIG. 10B is a second flowchart illustrating an example of operations performed by the portable terminal of the embodiment.

### DETAILED DESCRIPTION

### First Embodiment

Hereinafter, a display device and a program according to a first embodiment of the present invention will be described with reference to the drawings.

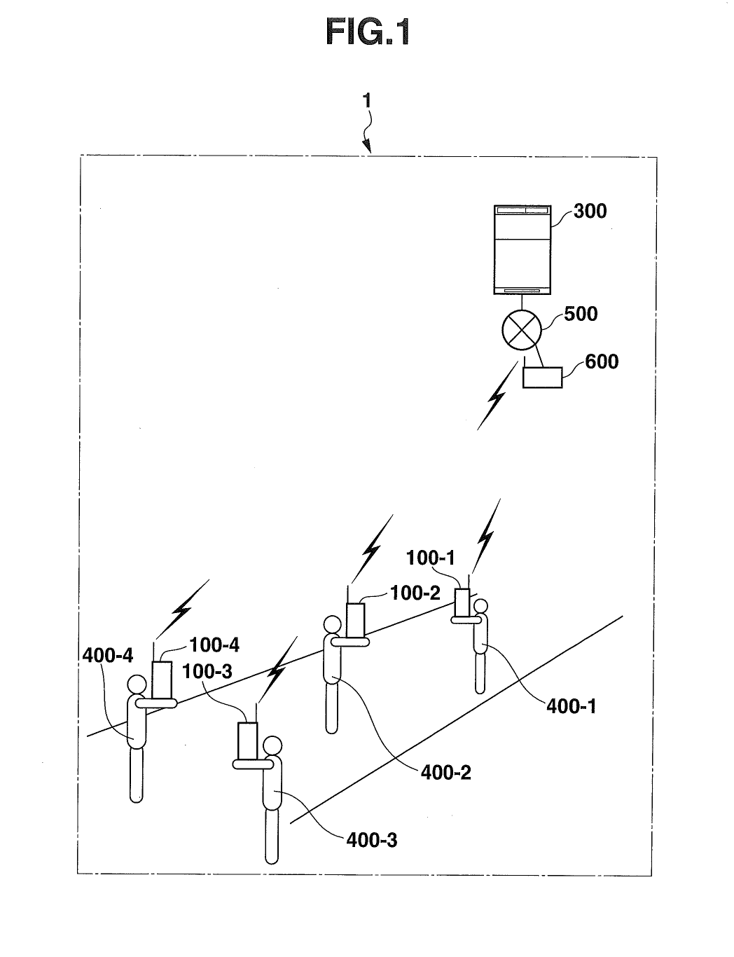

As illustrated in FIG. 1, an information providing system 1 has portable terminals 100-1 to 100-4 (hereinbelow, the portable terminals 100-1 to 100-4 is collectively called “portable terminal 100”) as display devices and a network server 300.

The portable terminal 100 is a terminal which is portable and has a wireless communication function such as a cellular phone, a smart phone, a tablet computer, or a notebook-sized personal computer. The portable terminal 100-1 is possessed by a user 400-1, the portable terminal 100-2 is possessed by a user 400-2, the portable terminal 100-3 is possessed by a user 400-3, and the portable terminal 100-4 is possessed by a user 400-4.

The portable terminal 100 performs modulation including changes in wavelength (color) in a time-series manner in correspondence with a tag ID as identification information of information (content) provided by the network server 300 and displays an image of a marker. By displaying the marker, the portable terminal 100 is able to transmit the tag ID to another portable terminal 100. Another portable terminal 100 captures the marker displayed by the portable terminal 100, performs image analysis to obtain the ID, and transmits the tag ID to the network server 300 via a wireless basestation 600 and a communication network 500.

The network server 300 performs communication with the portable terminal 100 via the communication network 500 and the wireless basestation 600. The network server 300 associates the content and the tag ID with each other and manages them. The content includes profile data, a text message, an image, computer graphics (CG), and the like of the user 400 transmitted from the portable terminal 100 to the network server 300 in accordance with an operation of the user 400. The network server 300 transmits the content corresponding to the tag ID transmitted from the portable terminal 100 to the portable terminal 100 as the transmitter of the tag ID.

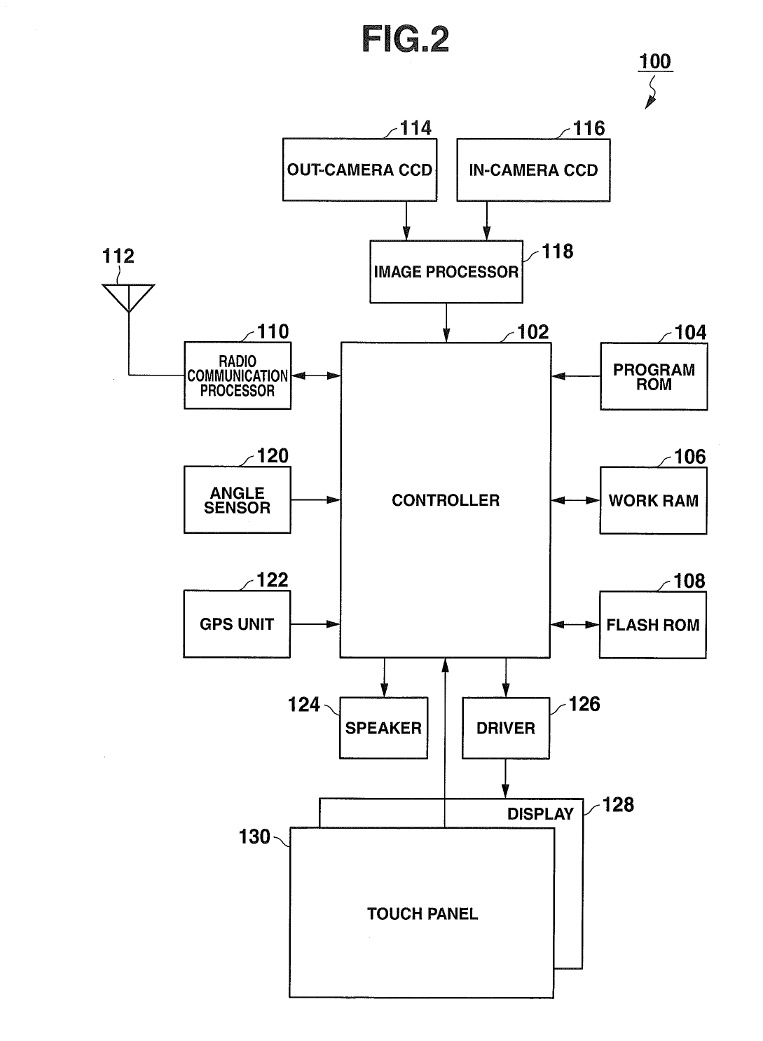

Next, the detailed configuration of the portable terminal 100 will be described. As illustrated in FIG. 2, the portable terminal 100 has a controller 102, a program ROM (Read Only Memory) 104, a work RAM (Random Access Memory) 106, a flash ROM (Read Only Memory) 108, a radio communication processor 110, an antenna 112, an out-camera CCD (Charge Coupled Device) 114, an in-camera CCD 116, an image processor 118, an angle sensor 120, a GPS (Global Positioning System) unit 122, a speaker 124, a driver 126, a display 128, and a touch panel 130.

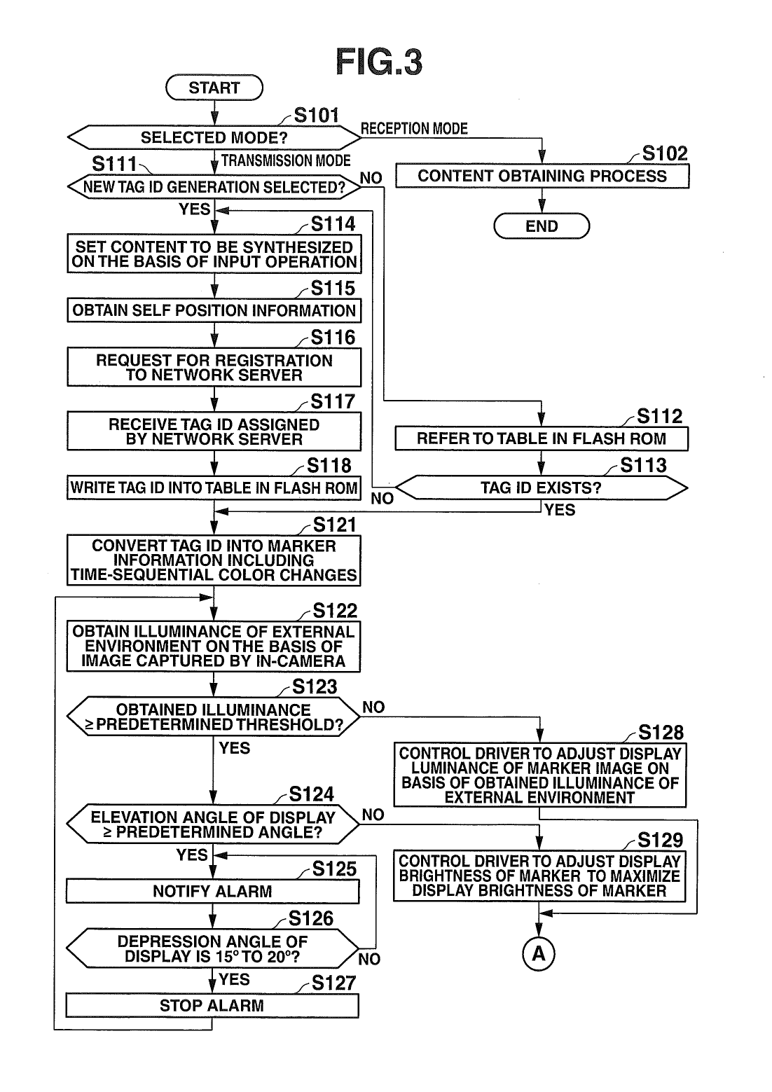

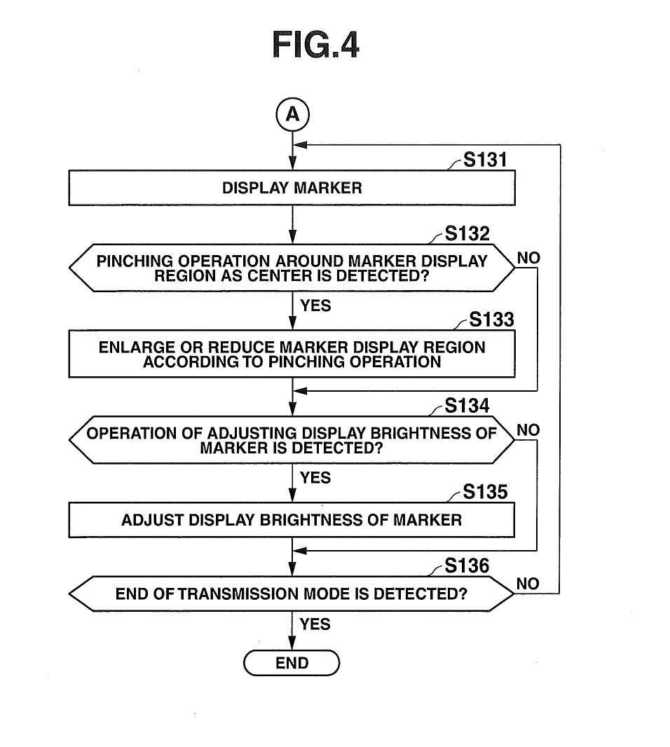

The controller 102 is constructed by, for example, a CPU (Central Processing Unit). The controller 102 controls various functions of the portable terminal 101 by executing software process in accordance with a program stored in the program ROM 104 (for example, a program for performing processes in FIGS. 3 and 4 which will be described later).

The program ROM 104 stores the program as described above. The work RAM 106 stores various information during execution of the software process according to the program. The flash ROM 108 stores a table in which a tag ID to be described later is registered.

The radio communication processor 110 is constructed by, for example, a radio frequency (RF) circuit, a baseband (BB) circuit, and the like. The radio communication processor 110 transmits/receives a radio signal via the antenna 112. The radio communication processor 110 encodes and modulates a transmission signal and demodulates and decodes a reception signal.

The out-camera CCD 114 is disposed, for example, on a face opposite to a face on which the display 128 in the casing of the portable terminal 100 is disposed. The out-camera CCD 114 captures (receives) light incident via a not-illustrated lens and converts an image signal obtained by the capture into digital data to generate a frame. The in-camera CCD 116 is disposed, for example, on a face on which the display 128 in the casing of the portable terminal 100 is disposed. The in-camera CCD 116 captures (receives) light incident via a not-illustrated lens and converts an image signal obtained by the capture to digital data to generate a frame.

The image processor 118 adjusts the picture quality and image size of the frames output from the out-camera CCD 114 and the in-camera CCD 116 and outputs, to the controller 102, so that the resultant image is displayed as a through image on the display 128.

The angle sensor 120 has therein an acceleration sensor and the like and detects an inclination (hereinbelow, called “inclination angle”) of the portable terminal 100. Further, the angle sensor 120 outputs information of the detected inclination angle to the controller 102. The GPS unit 122 receives a signal from a GPS satellite and measures the position of the portable terminal 100 on the basis of the signal. The position is expressed by latitude and longitude. Further, the GPS unit 122 outputs information of the measured position to the controller 102.

The speaker 124 outputs sound such as an alarm on the basis of sound data from the controller 102. The driver 126 outputs an image signal based on the image data output from the controller 102 to the display 128. The display 128 is constructed by, for example, an LCD (Liquid Crystal Display), a PDP (Plasma Display Panel), an EL (Electroluminescence) display, or the like. The display 128 displays an image (for example, a marker image to be described later) in accordance with the image signal output from the driver 126.

The touch panel 130 is disposed on the top face of the display 128 and is used by the user 400 to enter various instructions. The touch panel 130 has therein, for example, a not-illustrated transparent electrode, when a finger or the like of the user 400 touches the touch panel 130, a position where the voltage changes is detected as a contact position and outputs information of the contact position to the controller 102.

Subsequently, the operation of the portable terminal 100 will be described. FIGS. 3 and 4 are flowcharts showing the operation of the portable terminal 100.

The controller 102 in the portable terminal 100 determines whether a mode selected by the user 400 is a reception mode or a transmission mode (step S101).

The reception mode is a mode of a process in which a portable terminal 100 captures a marker image corresponding to a tag ID displayed in another portable terminal 100.

The transmission mode is a mode of a process in which the portable terminal 100 displays the marker image corresponding to the tag ID.

For example, on the display 128, a button image for selecting the reception mode (reception mode selection image) and a button image for selecting the transmission mode (transmission mode selection image) are displayed. In the case where the user 400 touches the top face of the display region of the reception mode selection image in the touch panel 130, the controller 102 determines that the reception mode is selected on the basis of information of the touched position from the touch panel 130. On the other hand, in the case where the user 400 touches the top face of the display region of the transmission mode selection image in the touch panel 130, the controller 102 determines that the transmission mode is selected on the basis of information of the touched position from the touch panel 130.

In the case where the reception mode is selected (“reception mode” in step S101), the controller 102 performs content obtaining process (step S102). Concretely, the out-camera CCD 114 captures the marker image corresponding to the tag ID displayed on the display 128 of another portable terminal 100. By the operation, visible light communication of the tag ID between the another portable terminal 100 and the portable terminal is performed. Further, the controller 102 obtains the tag ID on the basis of a change in the color of the marker and transmits the tag ID to the network server 300 via the wireless basestation 600 and the communication network 500. The controller 102 obtains content such as profile data, a text message, an image, CG, and the like corresponding to the tag ID transmitted from the network server 300, synthesizes the image of the content with the image captured by the out-camera CCD 114, and displays the resultant image on the display 128.

On the other hand, in the case where the transmission mode is selected (“transmission mode” in step S101), the controller 102 determines whether generation of a new tag ID is selected or not (step S111). For example, an instruction button image for instructing generation of the new tag ID is displayed on the display 128. In the case where the top face of the display region in the instruction button in the touch panel 130 is touched by the user 400 within predetermined time since the instruction button image is displayed, the controller 102 determines that the generation of the new tag ID is selected on the basis of the information of the touched position from the touch panel 130.

In the case where generation of the new tag ID is not selected (NO in step S111), the controller 102 refers to a table stored in the flash ROM 108 (step S112) and determines whether the tag ID is registered in the table or not (step S113).

In the case where generation of the new tag ID is selected (YES in step S111) or in the case where the tag ID is not registered in the table (NO in step S113), the controller 102 selects content such as profile data, a text message, an image, a CG, or the like synthesized with the image captured by another portable terminal 100 on the basis of an input operation to the touch panel 130 by the user 400 (step S114). For example, on the display 128, a menu screen for the user 400 to select the content is displayed. In the case where the user 400 touches the top face of the display region of the menu screen in the touch panel 130, the controller 102 determines the selected content on the basis of the information of the touched position from the touch panel 130. Further, the controller 102 performs a setting process of adding a predetermined value indicating that the content is selected to a flag associated with the determined content in the content stored in the work RAM 106.

Next, the controller 102 obtains information of the position from the GPS unit 122 (hereinbelow, called “self position information”) (step S115). The controller 102 transmits the content selected in step S114 and the self position information obtained in step S115 to the network server 300 via the communication processor 110, the antenna 112, the radio communication processor 600, and the communication network 500 and requests for registration of the tag ID (step S116).

The network server 300 receives the content and the self position information from the portable terminal 100 and associates the content with the tag ID, thereby assigning the tag ID to the content. At this time, the network server 300 recognizes the position of the portable terminal 100 on the basis of the self position information and associates the content with the tag ID other than the tag ID already assigned to content from another portable terminal 100 existing in a position within predetermined distance from the recognized position. Further, the network server 300 transmits the tag ID associated with the content to the portable terminal 100 as the transmitter of the content and the self position information.

The controller 102 of the portable terminal 100 receives the tag ID associated by the network server 300 via the antenna 112 and the radio communication processor 110 (step S117). Further, the controller 102 writes the received tag ID into the table stored in the flash ROM 108 (step S118).

After writing the tag ID into the table in step S113 or in the case where it is determined that the tag ID is registered in the table (YES in step S113), the controller 102 converts the tag ID in the table to marker information for generating a marker image including time-sequential color changes (step S121). For example, the controller 102 encodes the tag ID into a bit data string. Further, the controller 102 performs digital modulation based on the bit data string and obtains marker information including the time-sequential color changes.

The controller 102 obtains an image (captured image) captured by the in-camera CCD 114 and obtains illuminance of external environment on the basis of the captured image (step S122). The controller 102 determines whether or not the obtained illuminance is equal to or larger than a predetermined threshold (step S123). The threshold is stored in, for example, the work RAM 106.

In the case where the obtained illuminance is equal to or larger than the threshold (YES in step S123), the controller 102 obtains the inclination angle of the portable terminal 100 detected by the angle sensor 120. Further, the controller 102 determines whether or not the elevation angle of the display 128 is equal to or larger than predetermined angle on the basis of the elevation angle (step S124).

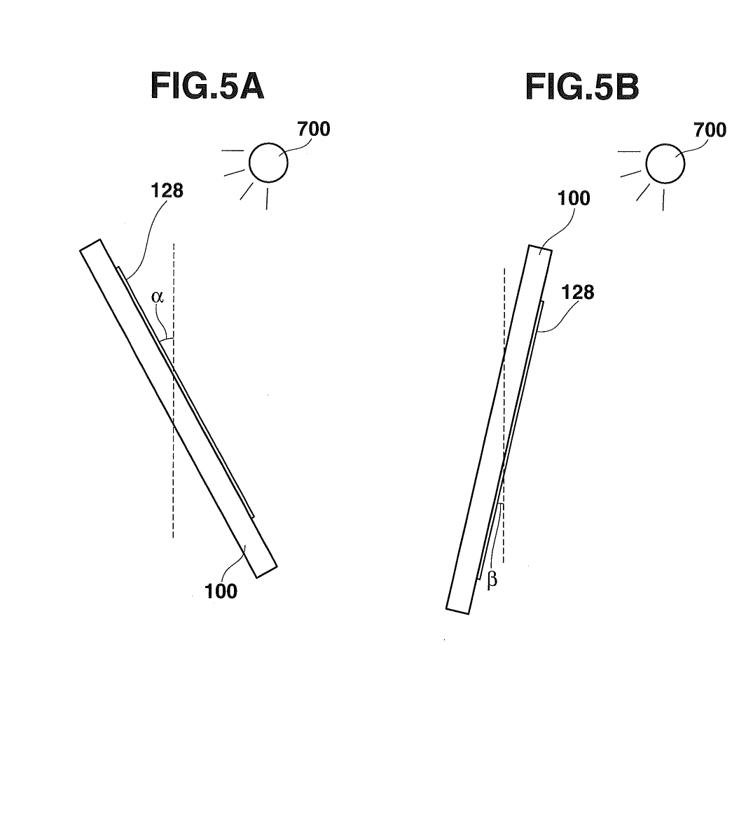

As illustrated in FIG. 5A, the elevation angle of the display 128 is an angle α in the counterclockwise direction from the vertical direction toward the display 128 and has a positive value when the surface of the display 128 faces upward. In the case where the elevation angle is large, as illustrated in FIG. 5A, the display 128 is irradiated with light from a light source 700 such as a lighting device or the sun, and an image displayed on the display 128 is not easily seen. The value of the predetermined angle is stored in, for example, the work RAM 106.

When the elevation angle of the display 128 is equal to or equal to a predetermined angle (YES in step S124), the controller 102 performs alarm notification (step S125). Concretely, the controller 102 outputs sound of a predetermined alarm from the speaker 124.

When an alarm is notified, the user 400 is able to recognize that even when a marker image is displayed on the display 128, another portable terminal 100 is not able to easily recognize the marker image due to too strong illuminance of the external environment. In this case, it is sufficient for the user 400 to take a measure of setting the surface of the display 128 so as to face downward or the like.

After alarm notification in step S125, the controller 102 obtains again the inclination angle of the portable terminal 100 detected by the angle sensor 120. Further, the controller 102 determines whether or not a depression angle of the display 128 lies in the range of 15° to 20° on the basis of the elevation angle (step S126).

As illustrated in FIG. 5B, in this case, the depression angle of the display 128 is an angle β in the clockwise direction from the vertical direction toward the display 128 and has a positive value when the surface of the display 128 faces downward. In the case where the depression angle has a positive value, as illustrated in FIG. 5B, the display 128 is not irradiated with light from the light source 700 such as a lighting device or the sun, and an image displayed on the display 128 is easily seen.

When the depression angle of the display 128 lies in the range of 15° to 20° (YES in step S126), the controller 102 stops the alarm (step S127). After that, the operations from recognition of the illuminance of the external environment (step S122) are repeated. On the other hand, when the elevation angle of the display 128 does not lie in the range of 15° to 20° (NO in step S126), the operations from the alarm notification (step S125) are repeated.

When the illuminance of the external environment is less than the threshold (NO in step S123), the controller 102 controls the driver 126 so as to adjust display luminance of the marker image on the display 128 on the basis of the illuminance of the external environment obtained in step S122 (step S128). Concretely, the controller 102 outputs marker information for generating a marker image including time-sequential color changes to the driver 126 and controls the driver 126 so that the higher the illuminance of the external environment is, the higher the display luminance of the marker image is.

When the elevation angle of the display 128 is less than predetermined angle (NO in step S124), the controller 102 outputs marker information for generating a marker image including time-sequential color changes to the driver 126 and controls the driver 126 so that the display luminance of the marker image on the display 128 becomes the maximum settable luminance (step S129).

After step S128 or S129, the routine moves to the operations in FIG. 4. The driver 126 generates a marker image on the basis of the marker information obtained in step S128 or S129 and sets the display luminance controlled by the controller 102 on the basis of the marker information obtained in step S128 or S129. Further, the driver 126 makes the display 128 display the marker image with the set display luminance (step S131).

In a state where the marker image is displayed on the display 128 of the portable terminal 100, another portable terminal 100 captures the displayed marker image. The visible light communication is performed between the portable terminal 100 and another portable terminal and the tag ID is transmitted/received. When the marker image is captured, another portable terminal 100 obtains the tag ID on the basis of the changes in the color of the marker image, and transmits the tag ID to the network server 300 via the radio base station 600 and the communication network 500. Further, the another portable terminal 100 obtains the content such as the profile data, a text image, an image, a CG, or the like corresponding to the tag ID transmitted from the network server 300, synthesizes the image of the content with the image captured, and displays the resultant image on the display 128.

After displaying the marker image in step S131, the controller 102 determines whether a pinching operation around the marker display region is detected or not on the basis of the touch position in the touch panel 130 (step S132).

The pinching operation is an operation by which the distance between two touch positions in the touch panel 130 gradually becomes longer or shorter. In the case where the user 400 touches two positions in the touch panel 130, the controller 102 obtains a change in the distance between the two touch positions on the basis of the information of the touch positions from the touch panel 130.

In the case where the pinching operation is detected (YES in step S132), the controller 102 performs control of enlarging or reducing the display region of the marker image in accordance with the pinching operation (step S133).

Concretely, in the case where the pinching operation by which the distance between two touch positions in the touch panel 130 becomes gradually longer is detected, the controller 102 controls the driver 126 so that the display region of the marker image on the display 128 is enlarged. The driver 126 enlarges the display region of the marker image on the display 128 under control of the controller 102. On the other hand, in the case where the pinching operation by which the distance between two touch positions in the touch panel 130 becomes gradually shorter is detected, the controller 102 controls the driver 126 so that the display region of the marker image on the display 128 becomes smaller. The driver 128 reduces the display region of the marker image on the display 128 under control of the controller 102.

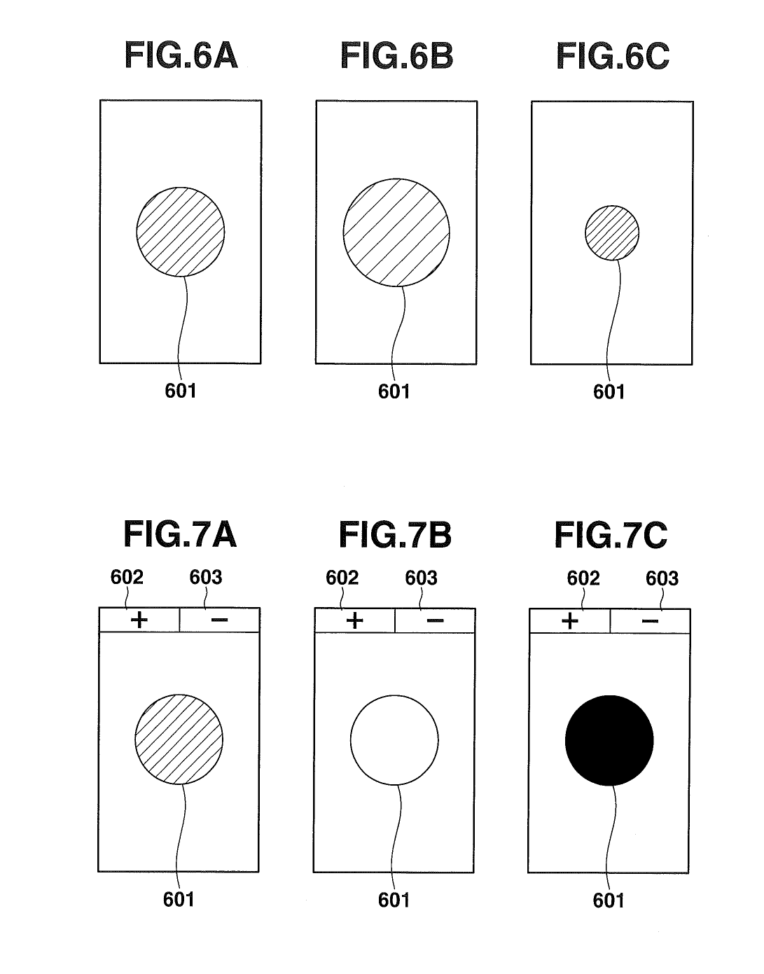

FIGS. 6A, 6B, and 6C illustrate an example of a change in the display region in a marker according to the pinching operation. In the case where the pinching operation by which the distance between two touch positions in the touch panel 130 becomes gradually longer is performed in a state where a marker 601 is displayed as illustrated in FIG. 6A, the marker 601 becomes larger as illustrated in FIG. 6B. On the other hand, in the case where the pinching operation by which the distance between two touch positions in the touch panel 130 becomes gradually shorter is performed in a state where the marker 601 is displayed as illustrated in FIG. 6A, the marker 601 becomes smaller as illustrated in FIG. 6C.

After the display region of the marker image is enlarged or reduced in step S133 or in the case where the pinching operation is not detected in step S132 (NO in step S132), the controller 102 determines whether an operation of adjusting display luminance of the marker image is detected or not on the basis of the touch positions in the touch panel 130 (step S134).

For example, as illustrated in FIGS. 7A, 7B, and 7C, buttons 602 and 603 for adjusting the display luminance are displayed on the display 128. The button 602 is operated to increase the display luminance, and the other button 603 is operated to decrease the display luminance. In the case where the user 400 touches the top face of the display region of the button 602 or 603 in the touch panel 130, the controller 102 determines that the operation of adjusting the display luminance of the marker image is detected on the basis of the information of the touch positions from the touch panel 130.

In the case where the operation of adjusting the display luminance of a marker image is detected (YES in step S134), the controller 102 adjusts the display luminance of the marker image in accordance with the operation (step S135).

Concretely, in the case where a touch to the top face of the display region of the button 602 is detected when the display luminance is initial standard luminance, the controller 102 increases the display luminance of the marker image to be higher than the standard luminance in accordance with the luminance level displayed in the button 602. On the other hand, in the case where a touch to the top face of the display region of the button 603 is detected, the controller 102 decreases the display luminance of the marker image to be lower than the standard luminance in accordance with the luminance level displayed in the button 603.

The luminance is adjusted within a range capable of being set by the buttons 602 and 603. A button for adjusting only contrast is also provided in some cases.

For example, in the case where the top face of the display region of the button 602 in the touch panel 130 is touched in a state where the marker 601 is displayed as illustrated in FIG. 7A, the display luminance of the marker 601 becomes higher as illustrated in FIG. 7B. On the other hand, in the case where the top face of the display region of the button 603 in the touch panel 130 is touched in a state where the marker 601 is displayed as illustrated in FIG. 7A, the display luminance of the marker 601 becomes lower as illustrated in FIG. 7C, and the contrast decreases.

After the display luminance of the marker image is adjusted in step S135 or in the case where the operation of adjusting the display luminance of the marker image is not detected in step S134 (NO in step S134), the controller 102 determines whether the end of the transmission mode is detected or not (step S136).

For example, a selection button image for selecting the end of the transmission mode is displayed on the display 128. In the case where the user 400 touches the top face of the display region of the selection button image in the touch panel 130, the controller 102 determines that the transmission mode is finished on the basis of information of the touch position from the touch panel 130. On the other hand, in the case where the user 400 do not touches the top face of the display region of the selection button image in the touch panel 130, the controller 102 determines that the transmission mode is not finished on the basis of information of the touch position from the touch panel 130.

In the case where the end of the transmission mode is detected (YES in step S136), the series of operations are finished. On the other hand, in the case where the end of the transmission mode is not detected (NO in step S136), steps S131 to S136 are repeated.

As described above, in the embodiment, the portable terminal 100 properly adjusts the display mode of the marker at the time of performing visible light communication by displaying the marker image corresponding to the tag ID in order to transmit/receive the tag ID as identification information of content to be provided to/from another portable terminal 100.

Concretely, the controller 102 detects operation of the user 400 on the basis of the touch state in the touch panel 130. Further, in the case where the pinching operation is performed, the controller 102 adjusts the size of the display region of the marker image. In the case where the operation for adjusting luminance is performed, the luminance of the marker image is adjusted. By adjusting the size and luminance of the display region of the marker image in accordance with the operation of the user 400 in such a manner, another portable terminal 100 is able to recognize the marker image more easily, and it is possible to perform information transmission by visible light excellently.

In the case where the luminance of the external environment is less than the threshold, the controller 102 adjusts the display luminance so that the higher the luminance is, the higher the display luminance of a marker image is. In the case where the luminance of the external environment is equal to or higher than the threshold and the inclination angle of the display 128 is less than the predetermined angle, the luminance of the marker image is adjusted so as to become the maximum. Consequently, another portable terminal 100 recognizes the marker image more easily, and it is possible to perform information transmission by visible light excellently.

In the case where the luminance of the external environment is equal to or higher than the threshold and in the case where the inclination angle of the display 128 is equal to or larger than a predetermined angle, the controller 102 performs alarm notification to encourage the user 400 to change the inclination angle of the display 128 to the depression direction. Further, in the case where the inclination angle of the display 128 becomes the depression angle, the controller 102 stops the alarm. By guiding the user 400 to properly change the inclination angle of the display 128 to the depression direction as described above, another portable terminal 100 recognizes the marker image more easily, and it is possible to perform information transmission by visible light excellently.

### Second Embodiment

Hereinafter, with reference to the drawings, a display device and a program according to a second embodiment of the present invention will be described. The same reference numerals are designated to circuit components and processes similar to those of the first embodiment and their description will not be repeated.

In the second embodiment, the portable terminal 100 on the side of displaying a marker image adjusts the marker image in consideration of environment data including not only the luminance of the external environment but also white balance or shade adjusted according to image capturing environment obtained by the portable terminal 100 on the reception side (the image capturing side).

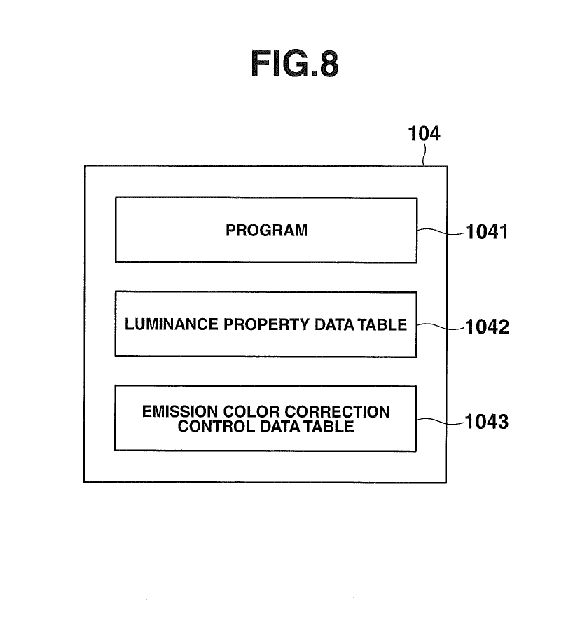

FIG. 8 is a diagram conceptually illustrating the internal configuration of the program ROM 104 in the embodiment.

A program 1041 indicates a program data body defining processes of the portable terminal 100 of the embodiment.

A luminance property data table 1042 stores data to be output to the driver 126 adjusting the display luminance of the display 128 in the first embodiment.

A emission color correction control data table 1043 stores environment data corresponding to adjustment data of the white balance (shade) of the image processor 118 in the portable terminal 100 on the light reception side (image capturing side).

The emission color correction control data table 1043 stores data for finely adjusting an emission color of the marker image in accordance with the environment data. The data is output to the driver 126 and used for adjusting lightness, saturation, and hue.

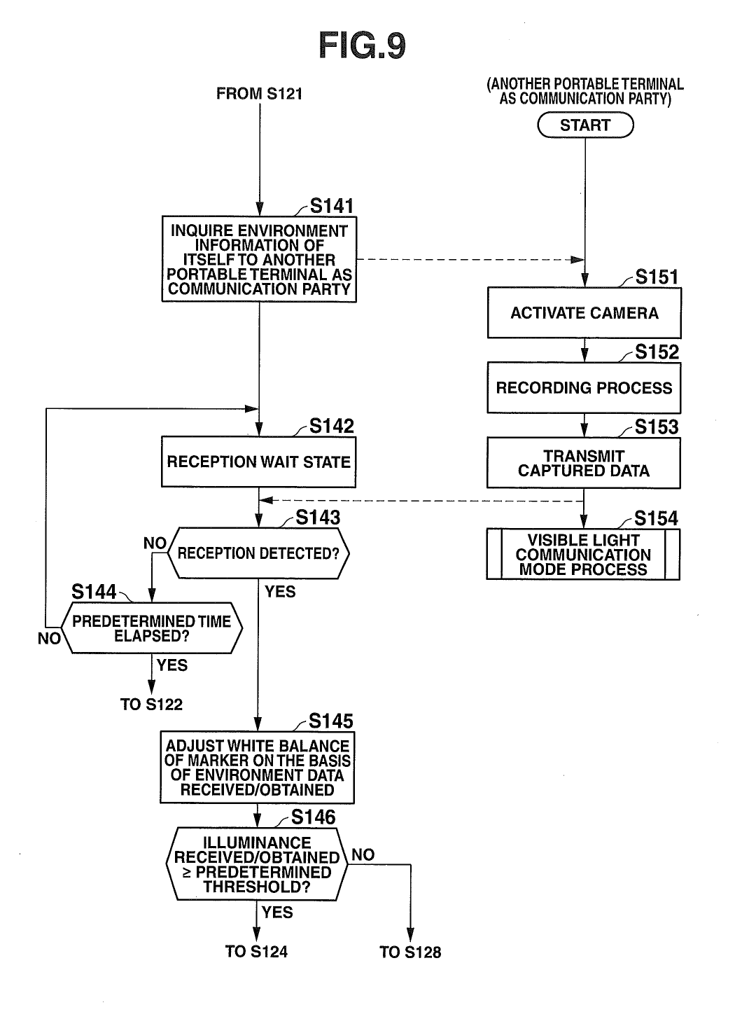

FIG. 9 is a flowchart illustrating operations of the portable terminal 100 in the embodiment. Specifically, the processes replace the processes in steps S122 and S123 in FIG. 3.

First, the controller 102 transmits data inquiring environment information of the environment of itself to another portable terminal 100 as the other side of communication via a radio communication infrastructure as a known technique (step S141).

The another portable terminal 100 which receives the inquiry activates the out-camera CCD 114 (or the in-camera CCD 116) and the image processor 118 (step S151). The another portable terminal 100 captures and records an image of the portable terminal (that is, itself) displaying the marker image (step S152) and transmits the captured data to the portable terminal as the sender of the inquiry (step S153).

After transmitting the inquiry, the controller 102 continues a reception wait state until reception of the captured data is detected by using the radio communication infrastructure (step S142).

The controller 102 determines whether reception of the captured data is detected or not (step S143) and, in the case where the reception is not detected (NO in step S143), determines whether predetermined time has elapsed or not (step S144).

In the case where it is determined that the predetermined time has not elapsed in step S144 (NO in step S144), the controller 102 returns to the reception wait state again. In the case where the predetermined time has elapsed (YES in step S144), the controller 102 determines that the captured data is not able to be obtained and advances to the process in step S122 in the first embodiment.

On the other hand, in the case where reception of the captured data is detected in step S143 (YES in step S143), the controller 102 obtains data regarding adjustment of white balance (shade) by another portable terminal 100 as the other party of transmission from the captured data. The controller 102 refers to the emission color correction control data table 1043 and adjusts the lightness, saturation, hue, and the like of the marker image so as to generate colors in accordance with the adjustment data of the white balance (shade) by the portable terminal 100 on the light reception (image capturing) side (step S145).

The controller 102 determines whether the illuminance of the captured data is equal to or larger than the a predetermined threshold or not (step S146).

In the case where the obtained illuminance is equal to or larger than the threshold (YES in step S146), the routine advances to step S124. In the case where the illuminance is less than the threshold (NO in step S146), the routine advances to step S128.

As described above, in the embodiment, at the time of performing visible light communication by displaying the marker image corresponding to the tag ID in order to transmit/receive the tag ID as identification information of content to be provided to/from another portable terminal 100, the portable terminal 100 properly adjusts the display mode (for example, lightness, saturation and hue) of the marker image in consideration of the image capturing environment seen from the reception side, particularly, shade such as white balance. By adjusting the marker image in accordance with the environment on the reception side, another portable terminal 100 recognizes the marker image more easily, and it is possible to perform information transmission by visible light excellently.

### Third Embodiment

Hereinafter, with reference to the drawings, a display device and a program according to a third embodiment of the present invention will be described. The same reference numerals are designated to circuit components and processes similar to those of the first embodiment and their description will not be repeated.

In the embodiment, the portable terminal 100 on the side of displaying the marker image adjusts the marker image to be displayed in consideration of environment data including white balance (shade) which is adjusted according to image capturing environment obtained by itself at a stage prior to a process of displaying (transmitting) the marker image.

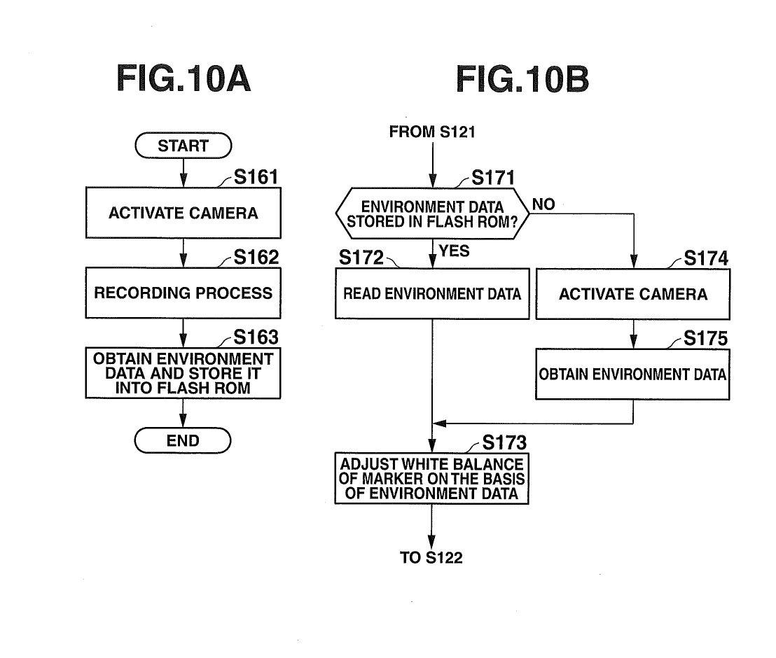

FIGS. 10A and 10B are flowcharts illustrating the operations of the portable terminal 100. Specifically, processes performed before the processes of the flowchart in FIG. 3 and processes (FIG. 10B) performed between the steps S121 and S122 in FIG. 3 are added.

First, in the flowchart of FIG. 10A, the controller 102 activates the out-camera CCD 114 (or the in-camera CCD 116) and the image processor 118 (step S161). Further, the controller 102 captures and records the environment of itself (step S162), obtains the environment data from the captured data, and stores it into the flash ROM 108 (step S163).

The controller 102 performs the processes in FIG. 10B between steps S121 and S122. Specifically, the controller 102 converts the tag ID to marker information for generating the marker image including time-sequential color changes (step S121). The controller 102 determines whether environment data is stored in the flash ROM 108 or not by the processes in FIG. 10A (step S171).

In the case where it is determined that environment data is stored (YES in step S171), the controller 102 reads the environment data (step S172), refers to the emission color correction control data table 1043 and adjusts the lightness, saturation, hue, and the like of the marker image so that colors are generated in accordance with the adjustment data of the white balance (shade) by the portable terminal 100 on the light reception (imaging) side (step S173).

On the other hand, in the case where it is determined that environment data is not stored (NO in step S171), the controller 102 activates the out-camera CCD 114 (or the in-camera CCD 116) and the image processor 118 (step S174). Further, the controller 102 captures and records the environment of itself (step S162), obtains the environment data from the captured data (S175), and moves to the process in step S173.

By adjusting the lightness, saturation, hue, and the like of the marker image in accordance with the environment of the portable terminal 10, another portable terminal 100 recognizes the marker image more easily, so that information transmission with visible light is performed excellently.

In the second and third embodiments, at the time of displaying the marker image, the initial process for optimizing the marker image is performed as described above. Even when the marker image is being displayed, the process of optimizing the marker image is performed in parallel in some cases. In this case, there is an advantage that, even in a state where the image capturing environment changes quickly, occurrence of the tag ID transmission error is suppressed.

It should be noted that the present invention is not limited by the description and the drawing for the embodiment described above, and it is possible to modify or the like to the above-described embodiment and drawings. For example, the function of the mobile terminal 100 is realized by executing a program by a computer, in some cases. The program for realizing the function of the mobile terminal 100 is stored in recording medium, such as CD-ROM in some cases, and is downloaded to a computer through a network in other cases.

Although preferred embodiments have been described above, the present invention is not limited to the specific embodiments but includes the invention described in the scope of claims for patent and its equivalents.

What is claimed is:

1. A display device comprising:
a display;
a converter for converting information to be transmitted to a marker used for visible light communication;
a display controller for displaying the marker converted by the converter on the display; and
an adjuster for adjusting a display mode of the marker displayed on the display.

2. The display device according to claim 1, further comprising an operation detector for detecting an operation from the outside,
wherein the adjuster adjusts the display mode of the marker displayed on the display on the basis of the operation detected by the operation detector.

3. The display device according to claim 2, wherein the operation detected by the operation detector is an operation related to adjustment of display size of the marker.

4. The display device according to claim 3, wherein the display has a function of a touch panel, and
the operation detected by the operation detector includes a pinching operation detected in the touch panel.

5. The display device according to claim 2, wherein the operation detected by the operation detector is an operation related to adjustment of display brightness of the marker.

6. The display device according to claim 1, further comprising a first determiner which determines brightness of environment in which the display device exists,
wherein the adjuster adjusts the display mode of the marker displayed on the display on the basis of the brightness determined by the first determiner.

7. The display device according to claim 6, wherein the adjuster adjusts display brightness of the marker displayed on the display on the basis of the brightness determined by the first determiner.

8. The display device according to claim 6, further comprising an image capturer,
wherein the first determiner determines brightness on the basis of an image captured by the image capturer.

9. The display device according to claim 6, further comprising a communicator,
wherein the first determiner determines brightness on the basis of an image received by the communicator.

10. The display device according to claim 1, further comprising a second determiner which determines image capture environment in which the display device exists,
wherein the adjuster adjusts the display mode of the marker displayed on the display on the basis of the image capture environment determined by the second determiner.

11. The display device according to claim 10, wherein the adjuster adjusts shade of the marker displayed on the display on the basis of the image capture environment determined by the second determiner.

12. The display device according to claim 10, further comprising an image capturer,
wherein the second determiner determines image capture environment on the basis of an image captured by the image capturer.

13. The display device according to claim 10, further comprising a communicator,
wherein the second determiner determines the image capture environment on the basis of an image received by the communicator.

14. The display device according to claim 1, further comprising:
a notification transmitter for executing notification to adjust the display mode of the marker;
a state determiner for determining a state of the display device; and
a notification controller for controlling notification executed by the notification transmitter on the basis of a determination result of the state determiner.

15. The display device according to claim 14, wherein the state determiner determines whether or not a display angle to a vertical direction component of the display is in a depression angle direction with respect to a predetermined angle; and
the notification controller controls to stop the notification by the notification transmitter in the case where the state determiner determines that the display angle to the vertical direction component of the display is in the depression direction with respect to the predetermined angle during execution of the notification by the notification transmitter.

16. The display device according to claim 1, wherein the information to be transmitted includes control information for performing control to synthesize a predetermined image in a position where the marker exists when an angle of view including the marker obtained by converting the information to be transmitted is captured by an external image capturing device.

17. A display control method comprising:
a converting step of converting information to be transmitted to a marker used for visible light communication;
a display control step of displaying the marker converted in the converting step; and
an adjusting step of adjusting a display mode of the marker displayed on the display control step.

18. A recording medium storing a program which makes a computer having a display device function as:
a converter for converting information to be transmitted to a marker used for visible light communication;
a display controller for displaying the marker converted by the converter in a display; and
an adjuster for adjusting a display mode of the marker displayed on the display.
